(19) United States
(12) Patent Application Publication
(10) Pub. No.: US 2026/0168828 A1
(43) Pub. Date: Jun. 18, 2026

(54) SYSTEMS AND METHODS FOR INDIRECT MEASUREMENT OF THE VOLUMETRIC FLOW GENERATED BY A COMPRESSOR

(71) Applicant: Philip Vodopiutz, Götzens (AT)

(72) Inventor: Philip Vodopiutz, Götzens (AT)

(21) Appl. No.: 19/535,640

(22) Filed: Feb. 10, 2026

Related U.S. Application Data
(63) Continuation of application No. PCT/EP2024/071525, filed on Jul. 30, 2024.

(30) Foreign Application Priority Data
Aug. 11, 2023 (EP) 23190997.9

(51) Int. Cl. G01F 1/34; F04B 51/00

(52) U.S. Cl. CPC G01F 1/34; F04B 51/00

(57) ABSTRACT

Disclosed techniques enable indirect measurement of the volumetric flow generated by a compressor in an environment with a known intake pressure. The compressor is connected with a measuring volume extending up to a closed check valve downstream of the compressor. The check valve is adapted for separating the compressor from a piping system supplying consumers. An activation module sends activation instructions to a pressure sensor for capturing a time series of pressure values and corresponding time stamps A regression module computes the slope of a linear regression line for pressure values captured during a regression time window between the activation timepoint of the compressor and a time point when the compressor reaches the operational working pressure. The volumetric flow generated by the compressor is computed by multiplying the slope with a proportionality factor defined as the ratio of the measuring volume to the intake pressure.

### CROSS-REFERENCE TO RELATED APPLICATION

This application claims priority to, and is a continuation of, PCT/EP2024/071525, filed on Jul. 30, 2024, and entitled “Systems and methods for indirect measurement of the volumetric flow generated by a compressor,” which in turn claims priority to EP 23190997.9 filed on Aug. 11, 2023, both of which are hereby incorporated by reference in their entireties.

### TECHNICAL FIELD

The present description generally relates to systems and methods for determining the volumetric flow generated by a compressor, and in particular relates to an indirect measurement method for determining the volumetric flow generated by a compressor in different operating modes of the compressor.

### BACKGROUND

Compressors are used to increase the pressure on a fluid and to transport the fluid through a piping system which supplies pressure consuming devices, referred to as consumers. The term fluid as used herein relates to a substance that has no fixed shape and yields easily to external pressure, such as a gas or a liquid. Thereby, the compressor changes the density of the fluid, or the volume filled by the fluid. Most use cases for compressors are in the field of gas compression. Nevertheless, although liquids are relatively incompressible, compressors can also be used in some cases for the transport of liquids, e.g., in pipelines. In the context of the herein disclosed approach for determining the volumetric flow generated by a compressor, the compressor type plays no role as long as it is working in a start-stop mode.

Typically, a compressor is coupled with the piping system for the fluid transport via a so-called check valve. As long as the check valve is closed, the compressor pumps up all volumes between the compressor unit and the check valve. The totality of these volumes is referred to as measuring volume herein. Most compressor types for gaseous media include a drying tower between the compressor unit and the check valve. In such cases, the volume of the drying tower is part of the measuring volume. The operating mode of the compressor during the pump-up phase is referred to as the pressure build-up mode/phase. For example, the check valve of a compressed air system opens when pressure parity prevails between the compressor side and the consumer side, e.g., pressure parity is reached at 80% of the maximum working pressure of the whole air pressure system. That is, the pump-up phase is defined from the start of the compressor to until 80% of this maximum (working) pressure is reached and the check valve opens. The pressure at which the check valve opens is referred to as the operational working pressure herein defining the lower boundary of the operating regime. That is, if the pressure in the piping system behind the check valve falls below the lower boundary of the operating regime the start of the compressor is triggered. The operating mode during the phase after the check valve has opened is referred to as the working mode.

In some very complex prior art systems, both in terms of cost and measurement technology, such as thermo-anemometers are being used to measure the volumetric flow generated by the compressor which is a key indicator of the compressor performance.

In experiments based on other prior art systems pressure data is sampled at very high sampling frequencies (>5 kHz) to monitor the pressure build-up phase and to determine the volumetric flow generated by the compressor. This is done by either measuring the time required to increase the pressure from a defined starting value to a defined end value or by measuring the pressure increase within a specified amount of time. However, such high frequency pressure sensors are expensive and complex devices. Further, they produce data in quantities unfeasible to be transferred by typical bus systems implemented in the compressor systems. Furthermore, the whole set-up lacks a fixed/defined measurement volume as, in particular with gaseous fluids, the pressure increase is measured using the known approximate/nominal volume of the drying tower which varies depending on several influencing factors (e.g., moisture content, leakages, etc.).

In many practical applications, cheaper and/or less complex low frequency pressure sensors (e.g., 10 Hz) are available, but measuring a pulsating high frequency (e.g., 10 kHz) process with a sampling rate of e.g., 10 Hz results in a very noisy representation of the underlying process as every measurement can be a minimum, a maximum or something in between. A combination of a relatively long time interval of 100 ms, an average duration of approx. 1 second for the whole build-up phase and a varying drying tower volume typically leads to a high variance (40% to 100%) in the calculated results.

### SUMMARY

Therefore, there is a need for systems and methods to accurately determine the volumetric flow generated by a compressor by using low complex standard low frequency pressure sensors in a simple arrangement to allow for permanent performance monitoring. This technical problem is solved by the independent claims for different operating modes of the compressor.

In a basic embodiment, a computer-implemented method is provided for indirect measurement of the volumetric flow generated by a compressor in an environment with a known intake pressure in that the compressor is connected to a measuring volume extending up to a closed check valve in the downstream of the compressor. In case of gas compressors, the intake pressure corresponds to the ambient pressure of the compressor. For example, a drying tower or another reservoir with known dimensions can be part of the measuring volume. The computer-implemented method can be executed by any standard computing device (e.g., processor control unit, general purpose computer, etc.). This embodiment is appropriate to measure the volumetric flow while the compressor is operated in the pressure build-up mode. The check valve is adapted for separating the compressor from a piping system adapted for the transport and/or storage of (liquid and/or gaseous) fluids. A pressure sensor (e.g., a standard pressure sensor providing pressure values at a low sampling rate in the order of 10 Hz) is located between the compressor and the check valve.

Initially, a control entity sends activation instructions to the pressure sensor for capturing a time series of pressure values and corresponding time stamps at a sampling rate which is set to capture 3 to 100 pressure values, advantageously 4 to 15 pressure values, preferably 12 pressure values, during the time needed by the compressor to pump up the measuring volume to a working pressure where the check valve opens (the operational working pressure). For large measuring volumes typically more pressure values are captured than for smaller volumes since the time required to pump up the large measuring volume is longer than the pump-up for small measuring volumes. The control entity can be part of the compressor aggregate, or it may be part of an external compressor control unit. In other words, the pressure sensor can be permanently activated, or it is activated before the compressor is activated, i.e., before the compressor unit starts compression of the fluid. As the amount of data, the bandwidth of the implemented data bus and/or the size of the data structure for data storage (memory) are often limited, it is advantageous to limit the measurements to the period when the compressor is active.

Upon the activation of the compressor, the captured pressure values with their time stamps are stored in a memory. For example, the memory can be implemented as a component of the compressor control unit, or it can be a remote storage device which is communicatively coupled with the pressure sensor and accessible by the computing device executing the computer-implemented method. Storing only pressure values after the compressor has been activated avoids wasting memory space for noisy pressure values.

For the pressure values captured during a regression time window between the activation timepoint of the compressor and the time point when the compressor reaches the operational working pressure, a linear regression line is fitted to the captured pressure values and the slope of the regression line is computed. In other words, the regression time window is defined as the time window comprising at least one time interval for fitting at least one linear regression line to the captured measurement values. Finally, the volumetric flow of the compressor is computed by multiplying the determined slope with a proportionality factor defined as the ratio of the measuring volume to the intake pressure.

For compressors with non-linear pump-up characteristics, a person skilled in the art can use an equivalent method that substitutes the calculation of linear regression lines by trendlines representing suitable non-linear mathematical dependencies or by splines fitted to the measured pressure values. The volumetric flow of such compressors can then be computed accordingly leading to a non-linear behavior of the volumetric flow curve.

In one implementation, the computer-implemented method includes a filtering step to filter out one or more leading and one or more ending pressure values from the time series captured in a regression time window such that at least a minimum number of pressure values remain for computing the linear regression line. In other words, the originally captured time series contains the minimum number of pressure values plus the pressure values which had been filtered out. The filtering step re-defines the regression time window by excluding at least the pressure value succeeding the activation timepoint of the compressor and excluding at least the pressure value preceding the timepoint when the compressor reaches the operational working pressure. That is, the operational working pressure can be considered as a pressure threshold above which the check valve opens and the compressor mode changes from the pressure build-up mode/phase to the phase where the piping system is supplied with fluid (supply mode/phase). The filtered-out pressure values often are affected by switch-on/switch-off artifacts and may not properly reflect the volumetric flow in the build-up mode. Therefore, the accuracy of the volumetric flow computation is advantageously improved by the filtering step.

In one embodiment, the method may include further steps to automatically determine when the compressor is activated. In this embodiment, once the pressure sensor has been activated, each current pressure value with its corresponding current time stamp is buffered in a data structure. That is, each newly captured pressure value with its time stamp is shifted into the data structure which has a given length which advantageously is larger than the regression time window. In one implementation, when the data structure is fully loaded, with each newly captured value the last value in the data structure (i.e., the eldest) is shifted out. In this implementation, the data structure behaves like a FIFO cache. The size of the FIFO cache allows to cover at least the pressure values captured within the regression time window. In an alternative implementation, a person skilled in the art may implement the data structure as a linear array for storing any newly captured value. Thereby, the regression time window may be implemented as a sliding window moving over the stored values such that the FIFO function is equivalently performed.

The method then continues with providing a plurality of predefined further regression windows, advantageously three regression windows, which may overlap in time, and determines a plurality of, advantageously three, pressure gradients between the current pressure value and at least one pressure value buffered earlier in the data structure by determining the slopes of the respective further linear regression lines for the buffered pressure values within the further regression windows. Each regression window ends with the buffered current pressure value and covers a different number of buffered (elder/earlier received) pressure values. In other words, within the regression time window, the plurality of further regression windows defines a plurality of sub-windows with each window starting with the current pressure value but ending with a different (elder/earlier received) pressure value. As a result, for each regression window, a further linear regression line is determined.

Using this optional embodiment, the activation of the compressor is detected when the slopes of the further regression lines for the further regression windows indicate exceeding a predefined noise threshold. When the further regression windows show an increase of the pressure values which cannot be interpreted as noise anymore (i.e., a first kink with increasing pressure values in the measured time series), it is assumed that the compressor unit has started working. The predefined noise threshold can be determined from previously determined pressure values with the compressor being deactivated. It is to be noted, that this optional embodiment also includes a situation where only a subset of regression windows (e.g., three out of five windows) exceeds the predefined noise threshold which may be seen as sufficient to detect the activation of the compressor. In this case, the subset of regression windows corresponds to said further regression windows.

As long as the compressor unit has not started compressing, deviations between the measured pressure values indicate noise. The predefined noise threshold can be computed by multiplying the sensor resolution, defined by the minimum pressure difference measurable, with a predefined tolerance factor f₁, with f₁>1. The result may be stored such that it is accessible for comparison with the further regression lines.

Alternatively, the activation of the compressor may be detected by an additional sensor which detects the operation of the compressor unit (e.g., a sensor measuring the electric current consumed by the power unit, or a vibration sensor detecting the start of vibrations of the compressor unit).

In one embodiment, the method may also include further steps to automatically determine when the compressor reaches its operational working pressure (when the check valve opens). The FIFO buffer which can be used to detect the activation of the compressor can also be used for detecting the time point when the check valve opens: At this point, a second kink occurs in the slope of the time series of captured pressure values where the slope decreases again. That is, after the activation of the compressor the method continues to buffer each current pressure value with its corresponding current time stamp in said data structure. In the same way as for the detection of the compressor activation, the method determines a plurality of slopes of linear regression lines for the buffered pressure values within a plurality of further regression windows between the current pressure value and earlier pressure values stored in the data structure. The amount and lengths of the further regression windows may be the same as used for the activation detection or may differ in number and size from the activation detection implementation. In any case, each further regression window ends with the buffered current pressure value and covers a different number of buffered (elder) pressure values. This results in strongly improved reliability of the calculated volumetric flow as a short-term pressure consumption during the pump-up phase can shift the pressure level for opening the check valve including some bounce-back-effect of measured pressure values along the time scale.

In this embodiment, a second kink caused by the decrease of the slope in the measured time series of pressure values can be identified if the slopes of the linear regression lines for the further regression windows indicate falling below an operating threshold defined by multiplying the slope values with a tolerance factor f₂, with 0<f₂<1.

In an alternative embodiment, the compressor in an environment with a known intake pressure is connected to an adapted measuring volume which, in addition to the basic embodiment, further comprises a test reservoir. Thereby, the measuring volume—including the test reservoir—extends up to a closed switching valve in the downstream of the compressor. The test reservoir has a known fixed test volume whereas the overall measuring volume between the compressor and the check valve is typically subject to fluctuations which may depend on the use of drying towers. The switching valve is located between the compressor and a check valve, wherein the check valve is again adapted for separating the compressor from a piping system supplying consumers. The switching valve is adapted for separating the check valve from the adapted measuring volume. That is, the test reservoir with its known fixed test volume can be pumped up to the maximum working pressure when the switching valve is closed because there is no automatic opening of the switching valve once the operational working pressure of the compressor is reached. In this alternative embodiment, a pressure sensor is connected to the test reservoir. Again, the piping system is adapted for transport of (compressed liquid and/or gaseous) fluids. Because the pressure sensor is measuring the pressure values in the known fixed test volume, very accurate indirect measurement of the volumetric flow of the compressor is possible when using an alternative computer-implemented method for indirect measurement of the volumetric flow of the compressor (during the pump-up phase) performing the following steps:

Activation instructions are sent to the pressure sensor for capturing a time series of pressure values and corresponding time stamps at a sampling rate which is set to capture 3 to 100 pressure values, advantageously 4 to 15 pressure values, preferably 12 pressure values, during the time needed by the compressor to pump up the adapted measuring volume to the maximum working pressure. Upon the activation of the compressor, the captured pressure values with their time stamps are stored in a memory. The slope of a linear regression line is computed for the pressure values captured during a regression time window between the activation timepoint of the compressor and the time point when the compressor reaches the maximum working pressure. Finally, the volumetric flow of the compressor is computed by multiplying the computed slope with a proportionality factor defined as the ratio of the adapted measuring volume to the intake pressure.

A filtering step similar to the optional filtering step in the basic embodiment may be used to exclude pressure values at the start and the end of the regression time window. In this embodiment, the regression time window excludes at least the pressure value succeeding the activation timepoint of the compressor and excludes at least the pressure value preceding the timepoint when the compressor reaches the maximum working pressure.

The activation of the compressor can be determined in the same way as for the basic embodiment. Upon activation of the pressure sensor, each current pressure value is buffered with its corresponding current time stamp in a data structure. Within the regression time window, a plurality of pressure gradients is determined between the current pressure value and earlier pressure values stored in the data structure by determining the slopes of further linear regression lines for the buffered pressure values within a plurality of regression windows. Each regression window ends with the buffered current pressure value and covers a different number of buffered pressure values. If the pressure gradients for the further regression windows indicate that a predefined noise threshold is exceeded, the method detects the activation of the compressor. The predefined noise threshold is determined as for the basic embodiment.

Further aspects of the description will be realized and attained by means of the elements and combinations particularly depicted in the appended claims. It is to be understood that both, the foregoing general description and the following detailed description are exemplary and explanatory only and are not restrictive as described.

### BRIEF DESCRIPTION OF THE DRAWINGS

FIGS. 1A, 1B are schematic diagrams illustrating two operating modes of an example standard compressor for air compression with a piping system (supplying consumers);

FIGS. 2A, 2B, 2C are schematic diagrams illustrating three operating modes of an example compressor for air compression with a piping system, wherein the compressor has an adapted measuring volume including an additional test reservoir;

FIG. 3 illustrates a legend for the symbols used in FIGS. 1A, 1B, 2A, 2B, 2C;

FIG. 4 is a simplified block diagram of a computer system for indirect measurement of the volumetric flow generated by a compressor based on pressure values obtained by a low frequency pressure sensor according to an embodiment;

FIG. 5A, 5B are simplified flow charts of two embodiments of computer-implemented methods for measurement of the volumetric flow generated by two different compressor embodiments where the volumetric flow is derived from pressure values obtained by a low frequency pressure sensor;

FIGS. 6A, 6B illustrate examples of regression windows used for determining the slope in a curve of captured pressure values according to an embodiment;

FIGS. 7A, 7B illustrate examples of a pressure curve for determining the slope of linear regression lines over the pressure build-up phase in two different compressor modes according to an embodiment;

FIG. 7C illustrates an example for determining a kink in a measured pressure curve during the pressure build-up phase indicating the opening of the check valve;

FIGS. 8A to 8D illustrate the impact of noise on the measurement of a pressure curve during the pressure build-up phase of a compressor; and

FIG. 9 is a diagram that shows an example of a generic computer device and a generic mobile computer device which may be used with the techniques described herein.

### DETAILED DESCRIPTION

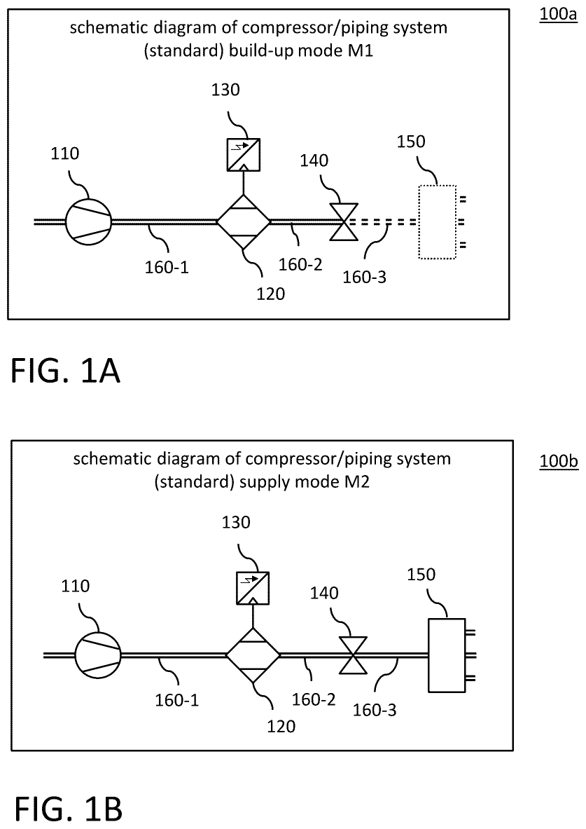

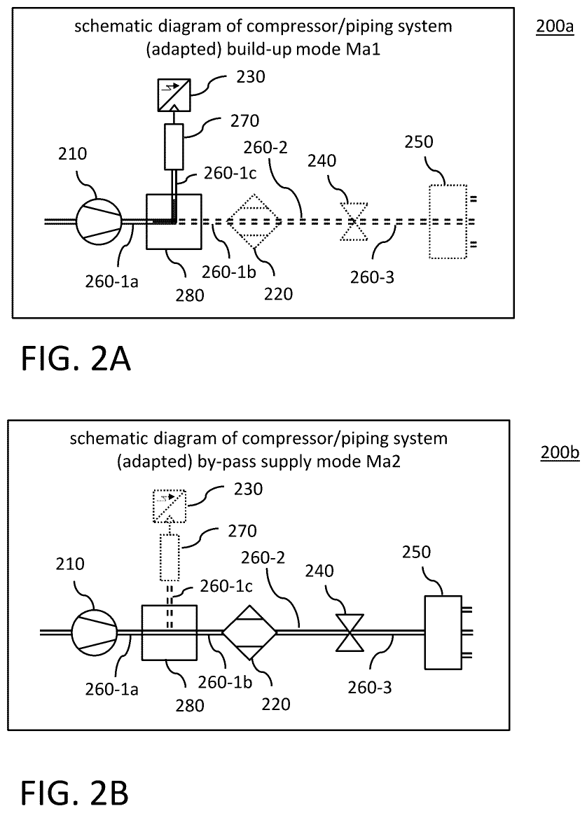

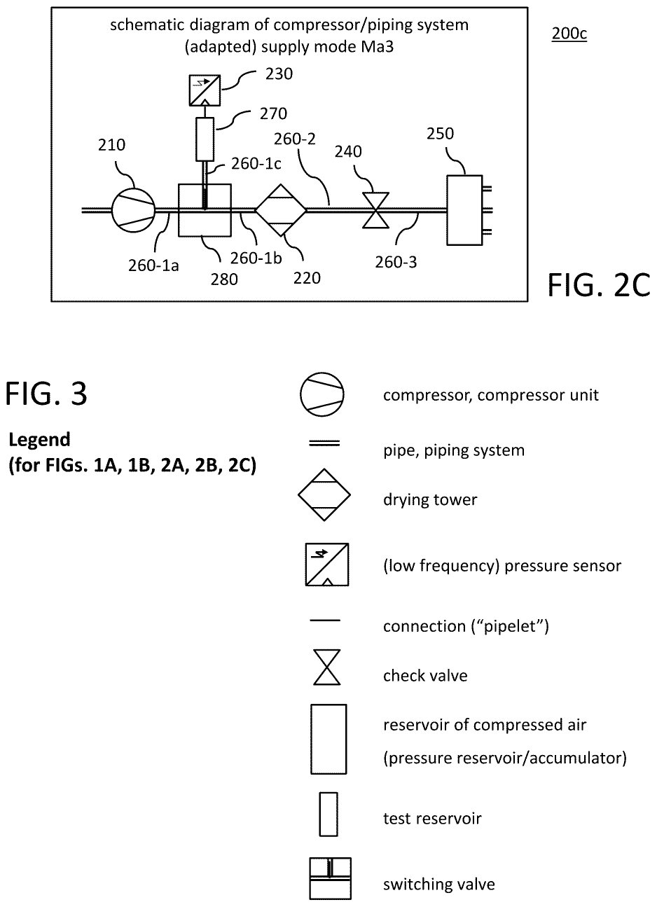

FIGS. 1A, 1B are schematic diagrams illustrating two operating modes 100a, 100b of an example standard compressor 110 for air compression with a piping system 160-1, 160-2, 160-3. FIGS. 2A, 2B, 2C are schematic diagrams illustrating three operating modes of further example compressor for air compression with a piping system, wherein the further compressor is connected to a measuring volume including an additional test reservoir. FIG. 3 illustrates a legend for the symbols used in FIGS. 1A, 1B, 2A, 2B, 2C.

The schematic diagram 100a of FIG. 1A illustrates the standard air compressor 110 during the pressure build-up phase (build-up mode M1). The parts 160-1, 160-2, 160-3 of the piping system convey fluid conveyed by the compressor to consumer devices 150 for operating such devices when the check valve is open. In mode M1, the check valve 140 is closed, thus decoupling all parts downstream including part 160-3 of the piping system from the compressor (illustrated by dashed lines). Typically, a drying tower 120 is located between the air compressor 110 and the check valve 140. The drying tower is connected to the compressor by connection part 160-1 and to the check valve by part 160-2 of the piping system (solid lines). A low-frequency pressure sensor 130 is connected with the drying tower volume via a connection pipelet, or is directly integrated into the drying tower volume, to measure pressure values in mode M1. In this embodiment, the measuring volume comprises all elements between the compressor 110 and the check valve (including the drying tower). The measuring volume is pumped up in M1 until the check valve opens.

The schematic diagram 100b of FIG. 1B illustrates the situation after the check valve 140 has opened and the system has switched to the supply mode M2 during which the consumer devices 150 are now supplied with fluid conveyed by the compressor 110 (illustrated by the continuous line of the supply part 160-3 of the piping system).

The schematic diagram 200a of FIG. 2A illustrates a further air compressor 210 during the pressure build-up phase (build-up mode Ma1). In this embodiment, the supply part 260-3 of the piping system behind the check valve 240 conveys fluid conveyed by the compressor to consumer devices 250 for operating such devices when the check valve 240 is open. In mode Ma1, the check valve 240 is closed, thus decoupling the supply part 260-3 of the piping system from the compressor (illustrated by dashed lines). Again, a drying tower 220 is located between the air compressor 210 and the check valve 240. In this embodiment, the drying tower is connected to a switching valve 280 which allows to decouple all parts downstream including part 260-1b of the piping system (part 260-1b connecting the switching valve with the drying tower and part 260-2 connecting the drying tower with the check valve) from the compressor 210. In mode Ma1, the switching valve 280 is closed illustrated by dashed lines of parts 260-1b, 260-2, and 260-3.

The switching valve 280 is adapted to pump up a test reservoir 270 (as part of an adapted measuring volume) located between the drying tower 220 and the compressor 210. A low frequency pressure sensor 230 is connected to the test reservoir 230 via a pipelet (or the sensor may be directly connected to the test reservoir, or the sensor may be directly placed inside the test reservoir) so that the pressure values in the test reservoir can be measured during the pressure build-up phase. While the switching valve is closed to separate the check valve 240 from the compressor 210, the compressor can pump up the test reservoir until the maximum working pressure which can be generated by the compressor 210 and can be reached because the opening of the check valve due to pressure parity, e.g., at 80% of the maximum working pressure, is avoided by the decoupling with the closed switching valve. That is, in mode Ma1, leakage analysis of the adapted measuring volume and the compressor 210 can be performed with a defined measuring volume comprising the test reservoir 270.

The schematic diagram 200b of FIG. 2B illustrates the situation after the pressure in the test reservoir 270 has reached the maximum working pressure. At this point, the test reservoir 270 can be decoupled from the compressor/piping system by closing the connection of the switching valve 280 to the test reservoir 270 represented by part 260-1c (dashed lines) and opening the connection to part 260-1b and part 260-2 of the piping system. That is, the switching valve is instructed to by-pass the test reservoir. At that moment, the maximum working pressure applies to the check valve 240 and the check valve immediately opens to supply the compressed fluid to the consuming devices 250. This mode is referred to as by-pass supply mode Ma2. The pressure in the test reservoir stays at the maximum working pressure in Ma2 whereas the pressure in the piping system will fall rapidly to the operational working pressure. This allows to perform leakage analysis on the test reservoir 270 while the remaining system already operates in the by-pass supply mode.

The schematic diagram 200c of FIG. 2C illustrates a situation where the switching valve 280 has simultaneously opened the connections to the test reservoir 270 and to the check valve. If the maximum working pressure has been reached before, again the check valve will immediately open. In this supply mode Ma3, the entire system operates above the operational working pressure and the pressure sensor 230 allows to measure the pressure values which reflect the whole compression process from compressor start to compressor stop including any consuming devices 250.

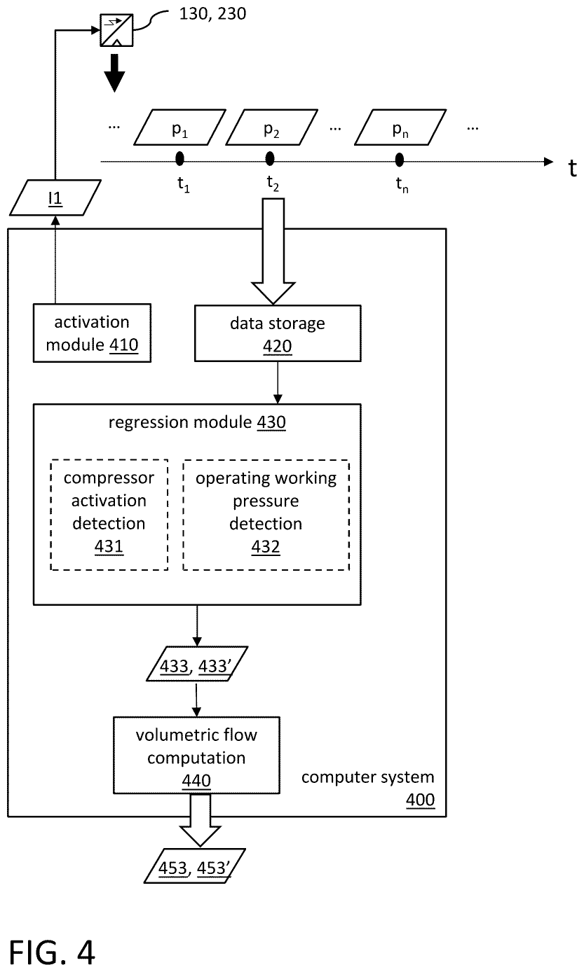

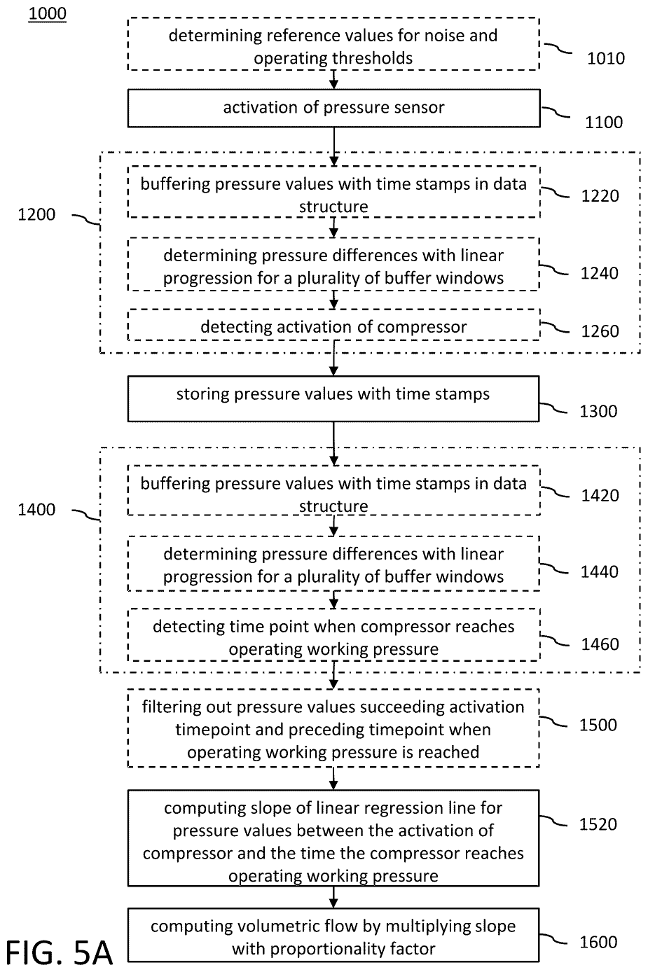

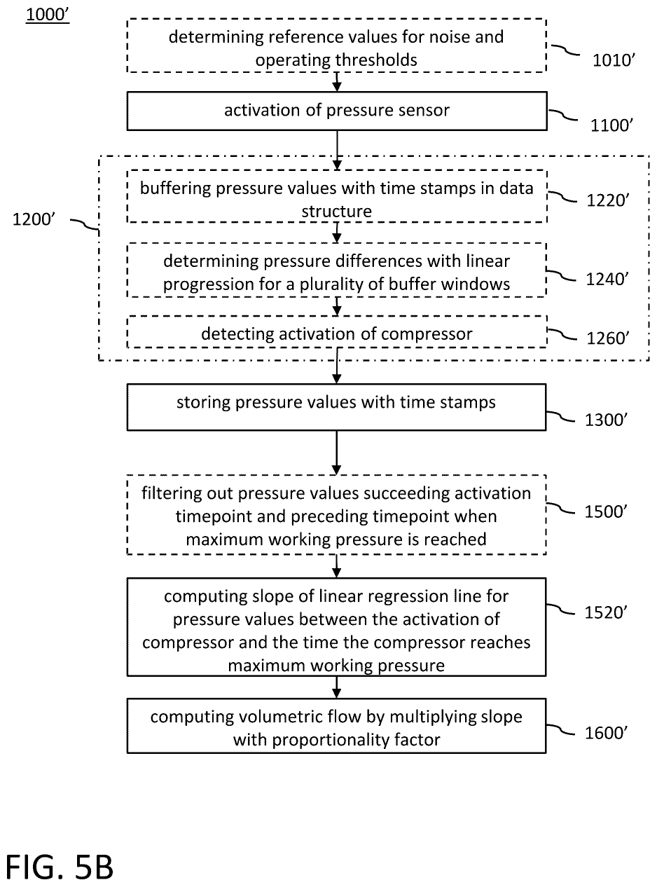

FIG. 4 is a block diagram of a computer system 400 which can be used to determine the volumetric flow generated by a compressor according to the embodiments shown in FIGS. 1A, 1B, 2A, 2B, 2C. It is to be noted that, although the illustrated compressor embodiments relate to gas compressors, the skilled person will understand that system 400 also applies to compressor embodiments for liquid fluid supply. FIGS. 5A, 5B are simplified flow charts of computer-implemented methods which can be executed by system 400 to indirectly measure the volumetric flow generated by a compressor. Thereby, FIG. 5A relates to a method 1000 for indirect measurement of the volumetric flow generated by a compressor which is not using a test reservoir, such as for example compressor 110 in FIGS. 1A, 1B, whereas FIG. 5B relates to a method 1000′ for indirect measurement of the volumetric flow generated by a compressor which is using such a test reservoir, such as for example compressor 210 and test reservoir 270 in FIGS. 2A to 2C.

Firstly, system 400 will be discussed in the context of method 1000 of FIG. 5A (compressor embodiment without test reservoir), which is a computer-implemented method for indirect measurement of the volumetric flow 453 generated by a compressor (e.g., compressor 110 of FIG. 1*) in an environment with a known intake pressure. The compressor is connected to a measuring volume extending up to a closed check valve in the downstream of the compressor. The check valve is adapted for separating the compressor from a piping system that is adapted for transport of liquid and/or gaseous fluids to consumer devices. A pressure sensor 130 is located between the compressor 110 and the check valve 140. In one embodiment, the pressure sensor 130 is communicatively coupled with computer system 400.

An activation module 410 of the system is adapted to send 1100 activation instructions l1 to the pressure sensor 130 for capturing a time series of pressure values p1 to pn with corresponding time stamps t1 to tn. Upon activation, the pressure sensor is capturing the time series at a low frequency sampling rate which is set to capture 3 to 100 pressure values, advantageously 4 to 15 pressure values, during the time needed by the compressor to pump up the measuring volume to an operational working pressure where the check valve opens. From experimental results it was derived that optimally, 12 pressure values are captured during this time interval. The optimum sampling rate is directly dependent on the relationship between the reference volumetric flow \dot{V}ref of the compressor, the size of the measurement volume, and the pressure difference (Δp=pend−pstart) between the start and the end of the pressure build-up phase.

System 400 then receives the captured time series via an appropriate machine-to-machine interface and stores 1300 the captured pressure values with their time stamps in a memory area 420 of system 400.

A regression module 430 computes 1520 the slope 433 of a linear regression line for the pressure values captured during a regression time window between the activation timepoint of the compressor and the time point when the compressor reaches the operational working pressure. In an equivalent embodiment for compressors with non-linear pump-up characteristics, the regression module 430 may compute a non-linear trendline representing suitable non-linear mathematical dependencies, or may compute a spline line fitting to the measured pressure values of the pressure build-up phase by splines fitted to the measured pressure values.

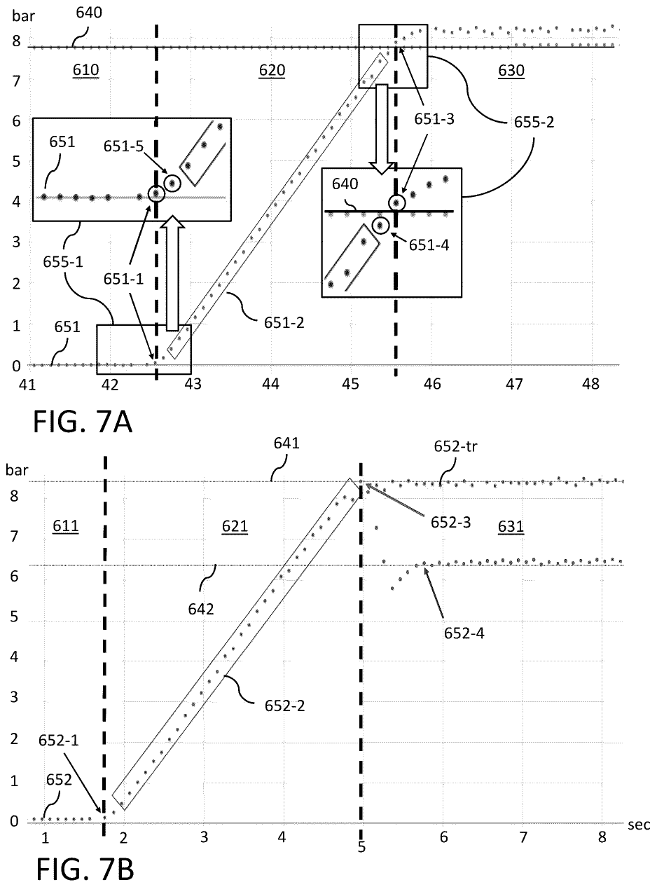

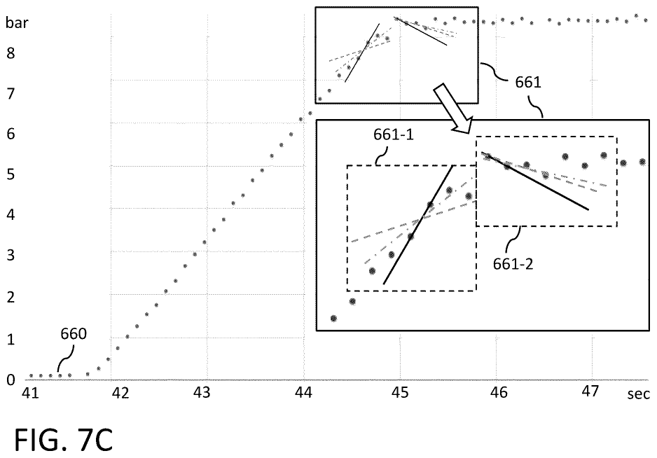

In an optional embodiment, an optional filtering step 1500 excludes at least the pressure value succeeding the activation timepoint of the compressor, and excludes at least the pressure value preceding the timepoint when the operational working pressure is reached and the check valve opens. However, the remaining pressure values of the captured time series after the filtering step still contain at least a minimum number of pressure values for computing the linear regression line. FIG. 7A shows an example of captured pressure values (represented by dots 651) during the pressure-build up phase of the compressor. The measured data shows that the slope of the pressure values is varying heavily with the first two pressure values (indicated by the circled pressure values in left insert 655-1) after the activation of the compressor (identified with pressure value 651-1). After reaching the operational working pressure the pressure curve flattens. The last measured pressure value 651-4 before reaching the pressure threshold for opening the check valve could still be included in the regression window (cf. right insert 655-2). However, to ensure that the slope result 433 from the regression is as accurate as possible, the filter step 1500 may eliminate the first two pressure values 651-1 and 651-5 after activation and the last pressure value 651-4 before reaching the operational working pressure from the regression window before computing the regression line for the remaining pressure values in the regression window (corresponding to the measured pressure values in the quadrangle 651-2).

The following example illustrates how to derive an optimal sampling rate in an embodiment which uses the filtering step 1500:
Nominal volumetric flow of the compressor \dot{V}ₙₒₘ=400 l/min≙6.667 l/s
Volume of the measuring volume Vₘₑₐₛᵤᵣₑ=1|
Targeted pressure difference between operational working pressure/end pressure and intake/starting pressure Δp=p_{end}−pₛₜₐᵣₜ=8 bar
   Therefore, the pressure increase (slope of the pressure build-up phase normalized to unity pressure difference) as measured in Vₘₑₐₛᵤᵣₑ is approximately 6.667 bar/sec

$$k = \frac{Δ p}{{V}_{meas}} \cdot {\dot{V}}_{nom} = \frac{1 bar}{1 l} \cdot 6.667 l / sec = 6.667 bar / sec$$

In other words, the rate to increase the pressure in the measuring volume by 1 bar is approximately 6.667 bar/sec
The time t needed to increase the pressure in Vₘₑₐₛᵤᵣₑ by Δp is 1.2 seconds, as

$$t = \frac{Δ p}{k} ≅ 1.2 sec$$

The optimum number of data points is 12 (10+2 to filter out) therefore the optimum sampling rate is equal to 12/1.2 sec which is 10 Hz

In order to de-noise the pressure measurements, a linear regression model is fitted to the 10 filtered pressure values. Experiments have shown that 10 data points provide the optimal balance between robustness of the calculation and cost of data generation (e.g., high frequency sensors, data volume, etc.).

FIG. 7A shows an example for determining the slope in an embodiment using filtering 1500. The x-axis represents time t with arbitrary values in seconds (41 s to 48 s). The y-axis represents the measured pressure in bar. The measured pressure values are illustrated as dots 651. Horizontal line 640 represents the pressure threshold (operational working pressure) at which the check valve opens. This threshold 640 is equivalent to the pressure limit in a pressure reservoir/accumulator for activating the compressor. In the example, three phases 610, 620, 630 are separated by vertical dashed lines. In phase 610, the compressor is inactive. That is, the measured pressure values represent noise measured by the low frequency pressure sensor. At the time point when the pressure value 651-1 exceeds the value of the noise pressure times the tolerance factor, the compressor is activated. At the time point when the pressure value 651-3 exceeds threshold 640, the check valve opens and the pressure reservoir/accumulator (the piping system) is pumped up during phase 630. The pressure values used for fitting the regression line to determine the slope are highlighted by quadrangle 651-2. As the filtering step is used, the initial three pressure values and the last pressure value during phase 620 are filtered out.

Turning back to FIG. 4 (and FIG. 5A), a volumetric flow computation module 440 finally computes 1600 the volumetric flow 453 generated by the compressor by multiplying the slope 433 with a proportionality factor defined as the ratio of the measuring volume to the intake pressure. The following mathematical considerations are based on gaseous fluids and show in detail why there is a proportionality between the determined slope 433 and the volumetric flow 453 which allows to use low-frequency pressure sensors for accurate determination of the volumetric flow of the compressor. The resulting equation is surprisingly simple and shows no dependencies on gas specific characteristics, thus it can be transferred to situations with liquid fluids.

List of parameters used for the derivation of the volumetric flow:
R=8,31441 (36) kJ kmol⁻¹K⁻¹: General (molar) gas constant
t: (Observation) time or transport duration in seconds or minutes

### Conditions in Front of the Compressor (Intake Side):

p₀: Intake pressure (e.g., standard norm pressure p₀=1.013525 bar=101.325 Pa)
T₀: Intake temperature (e.g., room temperature T₀=20° C.=295,13 K)
v₀: Amount of substance in intake atmosphere in mol or kmol
   For an Example where the Compressor is a Piston Compressor:
Vₛₜᵣₒₖₑ: piston stroke volume in m³
vₛₜᵣₒₖₑ: quantity of substance delivered during one piston stroke in moles or kmol

$${v}_{stroke} = \frac{{p}_{0} \cdot {V}_{stroke}}{R \cdot {T}_{0}}$$

tₛₜᵣₒₖₑ: Duration for one delivery/conveyance cycle in seconds or minutes

$$\frac{1}{{c}_{stroke}} :$$

Delivery/conveying frequency of the compressor in strokes/seconds or revolutions/seconds or rpm.
Nₛₜᵣₒₖₑ: Number of piston strokes or compression impacts (dimensionless)
v_{blow-by}: Leakage of the compressor during one piston stroke (in mol or kmol)
   Conditions after the Compressor (Compressed Air Side):
p_{E}: End-pressure (in bar or Pa), where: p_{E}>p₀ and p_{E}=p_{E}(t)
T_{E}: End-temperature (in ° C. or K)
v_{E}: amount of substance in the compressed air reservoir (in mol or kmol), where: v_{E}>vₛₜᵣₒₖₑ and v_{E}=v_{E}(t)
\dot{V}ₜᵣₐₙₛ: delivered/conveyed (equivalent) volumetric flow in m³/sec (or m³/min)
Vₘₑₐₛ: (defined) measuring volume in m³ (check valve or switching valve closed) in contrast to
V_{system}: (undefined) working volume in m³ (check valve or switching valve open)

### Experimental Observation

An experiment has shown the surprising result that the temperature of the delivered/transported fluid increases insignificantly, i.e., T_{E}≅T₀ (and T₀=Tₛₜᵣₒₖₑ), indicating a nearly isothermal change of state during the delivery/transport process (to build up a pressure reservoir).

### Mathematical Considerations:

The time dependency of the substance quantity in the compressed air reservoir results from the number of piston revolutions, the delivery frequency, the delivered substance quantity in one piston stroke and the delivery duration as

$${v}_{E} ( t ) = {N}_{stroke} \cdot \frac{1}{{t}_{stroke}} \cdot {v}_{stroke} \cdot t$$

Thereby, the ratio

$$\frac{{v}_{stroke}}{{t}_{stroke}}$$

in moles (or kmol) per sec (or min) is the molar delivery rate of the compressor and represents the amount of substance flow through the compressor. This can optionally be converted into a mass flow.

Thus, the following relationship for the time-dependent pressure in the measuring volume of the compressed air reservoir results from the general gas equation (for ideal gases):

$${p}_{E} ( t ) \cdot {V}_{meas} = {v}_{E} ( t ) \cdot R \cdot {T}_{E}$$

$${p}_{E} ( t ) = \frac{R \cdot {T}_{E}}{{V}_{meas}} \cdot {N}_{stroke} \cdot \frac{{v}_{stroke}}{{t}_{stroke}} \cdot t$$

Due to the observed isothermal behaviour (T_{E}≅T₀) this results in:

$${p}_{E} ( t ) ≅ \frac{R \cdot {T}_{0}}{{V}_{meas}} \cdot {N}_{stroke} \cdot \frac{{v}_{stroke}}{{t}_{stroke}} \cdot t = const \cdot t$$

For the slope k of the pressure build-up curve, between activation of the compressor until the operational working pressure is reached, the following applies (as a good approximation):

$$k = \frac{{dp}_{E}}{dt} = const = \frac{R \cdot {T}_{0}}{{V}_{meas}} \cdot {N}_{stroke} \cdot \frac{{v}_{stroke}}{{t}_{stroke}}$$

This means that there is a correlation between the gradient (pressure change on the side of the compressed air system) and the delivery rate (material flow rate or mass flow rate).

From the relation

$${v}_{E} ( t ) = {N}_{stroke} \cdot \frac{1}{{t}_{stroke}} \cdot {v}_{stroke} \cdot t$$

the delivery/transport/flow rate (until the working pressure is reached) is given by

$$\frac{{v}_{E}}{t} = {N}_{stroke} \cdot \frac{{v}_{stroke}}{{t}_{stroke}}$$

With the relation

$${v}_{stroke} = \frac{{p}_{0} \cdot {V}_{stroke}}{R \cdot {T}_{0}}$$

applies

$$\frac{{N}_{stroke}}{{t}_{stroke}} \cdot {v}_{stroke} = \frac{{N}_{stroke}}{{t}_{stroke}} \cdot \frac{{p}_{0} \cdot {V}_{stroke}}{R \cdot {T}_{0}}$$

This leads to:

$$k = \frac{{dp}_{E}}{dt} = \frac{R \cdot {T}_{0}}{{V}_{meas}} \cdot {N}_{stroke} \cdot \frac{{v}_{stroke}}{{t}_{stroke}} = \frac{R \cdot {T}_{0}}{{V}_{meas}} \cdot \frac{{N}_{stroke}}{{t}_{stroke}} \cdot \frac{{p}_{0} \cdot {V}_{0}}{R \cdot {T}_{0}} = \frac{{p}_{0}}{{V}_{meas}} \cdot \frac{{N}_{stroke}}{{t}_{stroke}} \cdot {V}_{stroke}$$

It should be noted that the delivered (equivalent) volumetric flow \dot{V}ₜᵣₐₙₛ can be represented via the volume Vₛₜᵣₒₖₑ, the delivery frequency of the compressor and the number of required strokes (compression impacts) as:

$${\dot{V}}_{trans} = \frac{{N}_{stroke}}{{t}_{stroke}} \cdot {V}_{stroke}$$

There is thus a direct proportionality between the slope k of the pressure build-up curve and the delivered volumetric flow \dot{V}ₜᵣₐₙₛ:

$$k = \frac{{dp}_{E}}{dt} = \frac{{p}_{0}}{{V}_{meas}} \cdot {\dot{V}}_{trans} = Const \cdot {\dot{V}}_{trans}$$

That is, \dot{V}ₜᵣₐₙₛ can be derived from slope k by multiplying the slope with the proportionality factor

$$P F = 1 / Const = \frac{{V}_{meas}}{{p}_{0}} .$$

It is to be noted that:
(i) the general gas constant no longer occurs in the relation, and
(ii) the relation is independent of the temperature of the medium.

This general formulation also applies to hardly compressible fluids, such as liquids, as long as a pressure change is achieved.

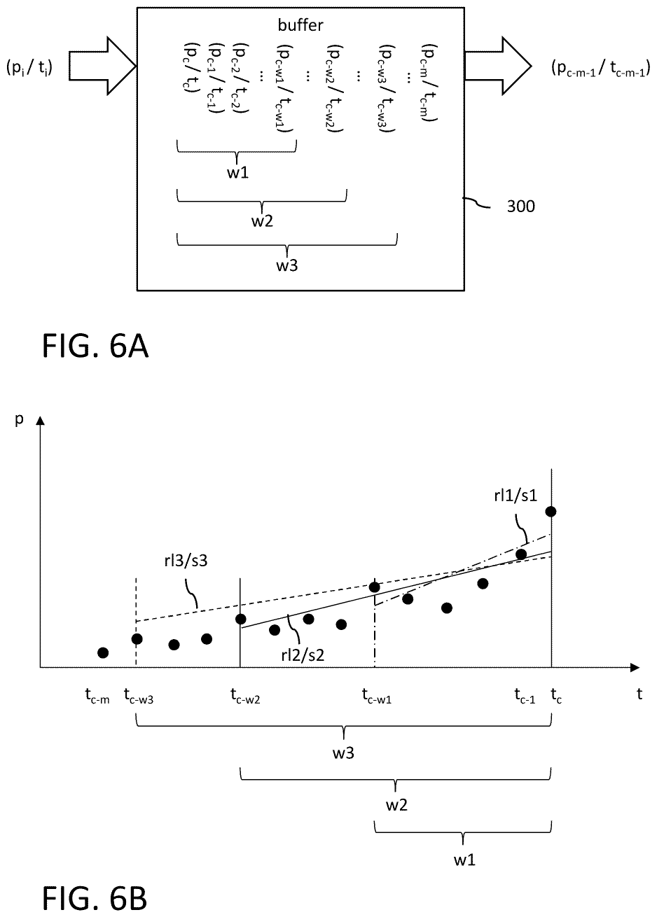

In an optional embodiment, the regression module 430 may have further sub-modules. A first submodule 431 may be used to automatically detect 1200 the activation of the compressor. This may be achieved by the following optional steps of method 1000. Upon activation of the pressure sensor, module 431 buffers 1220 each current pressure value with its corresponding current time stamp in a buffer data structure 300. FIG. 6A shows a buffer data structure 300 which buffers incoming pressure-timestamp value pairs (pi/ti) from the time series captured by the low-frequency pressure sensor. The buffer 300 supports a first-in-first-out storage where the current value pair (pc/tc) is at the first buffer position followed by earlier measured value pairs (pc-1/tc-1), (pc-2/tc-2), and so on. The buffer 300 has a limited size of m data points such that the last value pair in the buffer 300 (i.e., the value pair which has the earliest timestamp of all buffered value pairs) is pair (pc-m/tc-m). The buffer may be implemented as FIFO cache where each new value pair is shifted to the first buffer position and the last buffered value (pc-m-1/tc-m-1) is shifted out of the buffer when a new value pair (pc/tc) comes in. Alternatively, a FIFO like buffer (i.e., a buffer with a function that is equivalent to a FIFO) can be implemented by simply storing the entire time series received by system 400 and moving a sliding window with the size of the buffer over the time series.

In the next optional step, submodule 431 determines 1240, within the regression time window, a plurality of pressure gradients between the current pressure value and earlier pressure values buffered in the data structure by determining the slopes s1, s2, s3 of further linear regression lines rl1, rl2, rl3 for the buffered pressure values within a plurality of regression windows w1, w2, w3. Each regression window ends with the buffered current pressure value pc and covering a different number of buffered pressure values. FIG. 6A shows three possible regression windows w1, w2, w3 extending from the current value pair (pc/tc) to (pc-w1/tc-w1), (pc-w2/tc-w2), and (pc-w3/tc-w3), respectively. FIG. 6B illustrates how sub-module 431 can determine a regression line for each regression window by fitting a straight line into the respective pressure values. The captured pressure values (in FIG. 6B with pc-m≤pi≤pc) are plotted over their timestamps tc-m to tc. The timestamp of the current pressure value is the latest timestamp on the time axis t. For regression window w3 regression line rl3 is determined with slope s3. For regression window w2 regression line rl2 is determined with slope s2. For regression window w1 regression line rl1 is determined with slope s1. The slopes are different for the various regression windows. If the pressure gradients corresponding to the determined slopes s1 to s3 exceed a predefined noise threshold for all regression windows w1 to w3 of the plurality of regression windows, the activation of the compressor is detected 1260. The detected time point of the compressor activation is then used as the lower boundary for the regression window used for the computation of the volumetric flow.

The predefined noise threshold may be determined 1010 from previously determined pressure values with the compressor being deactivated, wherein the sensor resolution is multiplied with a predefined tolerance factor f₁, with f₁>1, and the result is stored as the predefined noise threshold.

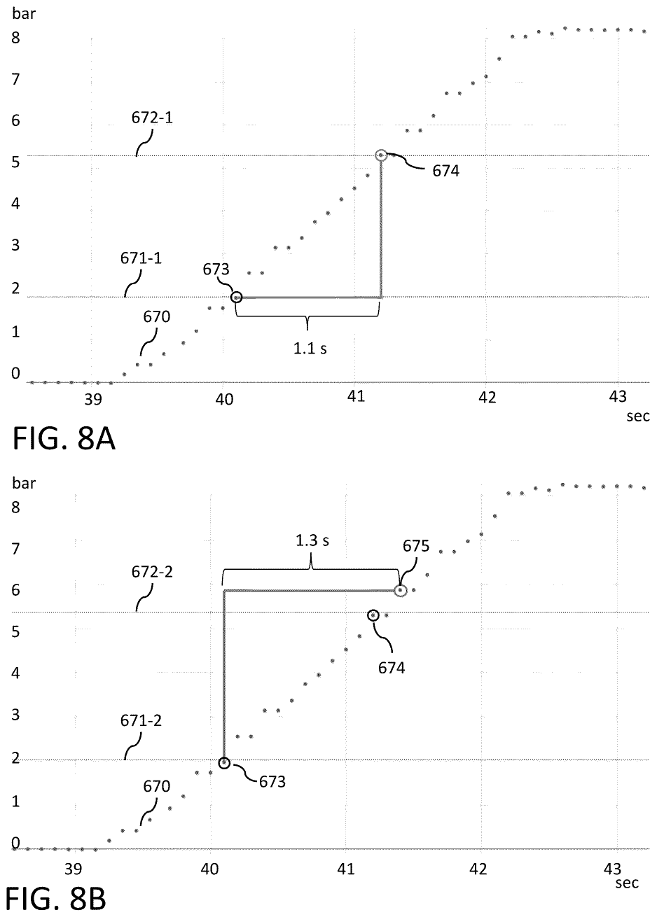

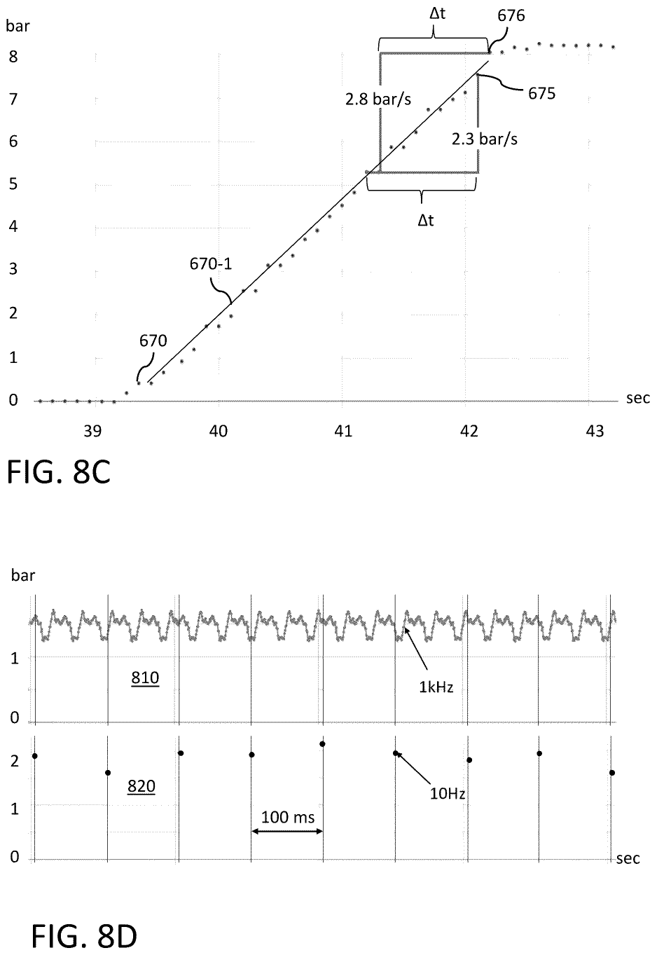

FIG. 8A and FIG. 8B illustrate the influence of noise on low frequency pressure measurements on the determination of the slope of the pressure curve in the pressure build-up phase. The disadvantageous noise effect is reduced by determining the previously described regression line for pressure values obtained during the pressure build-up phase of the compressor.

FIG. 8A shows a pressure value curve 670 during the pressure build-up phase of the compressor and illustrates the noise related error in measuring a time interval needed for increasing the pressure from a first pressure limit pA 671-1 to a second pressure limit pB 672-1. Case 1: The pressure value in circle 674 is already slightly above the second pressure limit 672-1 and the corresponding time interval to increase from pA to pB is 1.1 s. Due to noise, the following pressure value is falling again below the second pressure limit. FIG. 8B shows the same pressure value curve 670 during the pressure build-up phase of the compressor and illustrates the noise related error in measuring a time interval needed for increasing the pressure from a further first pressure limit pA 671-2 to a further second pressure limit pB 672-2. Both pressure limits are shifted upwards (e.g., by 0.1 bar) with respect to those given in FIG. 8A. The last pressure value before pressure limit pA is the same as in FIG. 8A. The pressure value in circle 674 is now slightly below the second pressure limit pB. The following pressure value is again below the second pressure limit pB due to noise. In this case, the circled pressure value 675 is the first pressure value above pB. The time interval to reach value 675 is 1.3 s in the measured example. That is, there is a substantial difference in the measured time interval between a fixed pressure interval (pB-pA) leading to substantially different slopes of the regression line resulting entirely from the noise in the data.

FIG. 8C illustrates an equivalent noise effect with regard to varying pressure gradients for time intervals of the same length. FIG. 8C shows the same pressure value curve 670 as FIG. 8A. The pressure difference is measured for a time interval Δt starting with two noisy pressure values having the same value. When starting from the earlier noisy pressure value and adding Δt, the pressure difference up to pressure value 675 is determined as 2.3 bar. Adding the same Δt to the later noisy pressure value as start for the time interval, a pressure value 676 is resulting in a pressure difference of 2.8 bar. Again, this is a substantial deviation caused by noisy pressure values. Using a regression line 670-1 in accordance with an embodiment, achieves a denoising defect on the pressure curve during the pressure build-up phase and leads to an almost accurate volumetric flow value.

FIG. 8D shows two pressure curves where noise values are sampled before the activation of the compressor. The upper curve 810 was sampled with a high frequency pressure sensor at 1 kHz. The lower curve 820 was sampled with a low frequency pressure sensor at 10 Hz (sampling points are the dots on the vertical lines illustrating the respective time intervals).

Turning back to FIG. 4, a further optional sub-module 432 of the regression module 430 may be used to automatically detect 1400 the time point when the operational working pressure is reached during the pressure build-up phase. Sub-module 432 (operational working pressure detection) makes use of the same buffer data structure 300 as sub-module 431. That is, upon activation of the pressure sensor, it continuous to buffer 1420 each current pressure value with its corresponding current time stamp in the buffer data structure 300. It also makes use of the same plurality of regression windows as sub-module 431 to determine 1440 a plurality of pressure gradients between the current pressure value and earlier pressure values buffered in the data structure by determining the slopes s1, s2, s3 of the respective linear regression lines rl1, rl2, rl3 for the buffered pressure values. If the pressure gradients for the further regression windows w1 to w3 indicate falling below an operating threshold the current time point is detected 1460 as the time point when the compressor reaches the operational working pressure. Thereby, the operating threshold is obtained as a previously determined slope of a linear regression line for pressure values that depends on the sensor resolution and previously captured data between a previous activation timepoint of the compressor and a corresponding previous time point when the compressor has reached the operational working pressure.

FIG. 7C shows an example of a measured pressure curve 660. After the activation of the compressor, the curve increases at a relatively constant slope. At t≈45 (in area 661), the measured values exceed the pressure threshold where the operational working pressure is reached and the check valve opens. This area of interest 661 is enlarged in the lower right section of FIG. 7C to illustrate that three slopes for three regression windows of different lengths allow to detect a kink in curve 660 which indicates the opening of the check valve. In area 661-1 the slopes for three different regression windows are above the threshold indicating that the pressure in the measuring volume is still increasing at a high rate. Typically, at some point in time, the slopes of the three regression windows are still positive but have declined below the threshold for the first time. In area 661-2 of the example, starting with the pressure value captured at t≈45, the slopes of the three regression windows have already become negative. In case these slopes indicate falling below an operating threshold obtained as previously determined slope of a linear regression line for pressure values previously captured between a previous activation timepoint of the compressor and a corresponding previous time point when the compressor has reached the operational working pressure, this indicates the end of the pressure build-up phase because the operational working pressure has been reached and the check valve has opened.

FIG. 5B is a flow chart of a computer-implemented method 1000′ which can be used to determine the volumetric flow of a compressor in a setup with a test reservoir as described in FIG. 2*. The method 1000′ largely corresponds to the method 1000 with a few differences. As described earlier, in the compressor embodiment of FIG. 2*, during the pressure build-up phase, the compressor is decoupled from the check valve by the switching valve which connects the compressor with the test reservoir and separates the check valve from the measuring volume. For this reason, the compressor can pump up the test reservoir up to the maximum working pressure because the check valve cannot open at the operational working pressure as it is separated by the switching valve.

For the same reason, the steps 1400 of method 1000 have no correspondence in method 1000′ because it is not possible to automatically detect when the operational working pressure is reached as the test reservoir is always pumped up to the maximum working pressure. Only after the switching valve is instructed to open, the check valve immediately opens when the maximum working pressure is reaching the check valve.

Computer-implemented method 1000′ is for indirect measurement of the volumetric flow generated by a compressor 210 (cf. FIG. 2*) in an environment with a known intake pressure, where the compressor has a measuring volume comprising a test reservoir 270. In this compressor embodiment, the measuring volume during the pressure build-up phase extends up to the closed switching valve 280 in the downstream of the compressor. As shown in FIG. 2*, the switching valve 280 is located between the compressor 210 and the check valve 240. The check valve separates the compressor 210 from a piping system 260-3 for transport of liquid and/or gaseous fluids. The pressure sensor 230 is connected to or located in the test reservoir 270 (e.g., by a pipelet connection between the test reservoir and the pressure sensor). The method 1000′ starts with activation module 410 sending 1100′ activation instructions to the pressure sensor for capturing a time series of pressure values pi and corresponding time stamps ti at a sampling rate which is set to capture 3 to 100 pressure values, advantageously 4 to 15 pressure values, preferably 12 pressure values, during the time needed by the compressor to pump up the measuring volume to the maximum working pressure. Upon activation of the compressor, data storage 420 stores 1300′ the captured pressure values with their time stamps. Regression module 430 computes 1500′ the slope 433′ of a linear regression line for the pressure values captured during a regression time window between the activation timepoint of the compressor and the time point when the compressor reaches the maximum working pressure. Volumetric flow computation module 440 computes 1600′ the volumetric flow 453′ generated by the compressor by multiplying the slope 433′ with a proportionality factor defined as the ratio of the measuring volume to the intake pressure.

FIG. 7B shows an example measurement with a low frequency pressure sensor in a setup with a test reservoir in accordance with FIG. 2*. In phase 611, the compressor is deactivated and the measured pressure values 652 correspond to the pressure noise. At the transition from phase 611 to the pressure build-up phase 621 indicated by point 652-1 (at the left vertical dashed line), the compressor is activated and starts to pump up the measuring volume including the test reservoir. Because the switching valve decouples the check valve from the compressor during phase 621, the pressure in the test reservoir reaches the maximum working pressure 641. At this point 652-3, the switching valve is controlled to open the connection to the check valve and the check valve immediately opens. In the example of FIG. 7B, the switching valve also decouples the test reservoir from the connection between the compressor and the check valve and the system enters into operation phase 631 where the compressed fluid is delivered to the piping system (indicated by the right vertical dashed line). The pressure values 652-tr measured by the low frequency pressure sensor in phase 631 still measure the maximum working pressure which prevailed in the compressor before the check valve opened (by-pass supply mode Ma2, cf. FIG. 2B). In this setup, the low frequency pressure sensor can be used to perform a leakage test on the test reservoir. The pressure values 652-4 show the pressure in the piping system after the check valve has opened. In this setup, the pressure values 652-4 are measured by a further pressure sensor because the low frequency pressure sensor of the test reservoir is decoupled from the piping system by the switching valve. However, in a setup where the switching valve does not close the connection between the test reservoir and the piping system before the check valve opens, the low frequency pressure sensor of the test reservoir would measure similar pressure values as the ones shown by the pressure curve 652-4 during phase 631 (adapted supply mode Ma3 according to FIG. 2C).

Similar as method 1000, method 1000′ can include a filtering step 1500′ to filter out some pressure values before computing said regression line. That is, the captured time series contains at least five sampled pressure values and the regression time window excludes at least the pressure value succeeding the activation timepoint of the compressor and excludes at least the pressure value preceding the timepoint when the compressor reaches the maximum working pressure. In the example, quadrangle 652-2 includes the filtered pressure values which are used for determining the regression line. In the example, the first pressure value and the last pressure value in phase 621 are filtered out.

Turning back to FIG. 5B, like method 1000, method 1000′ optionally can also include steps 1200′ for automatically detecting the activation of the compressor. Upon activation of the pressure sensor, module 431 buffers 1220′ each current pressure value with its corresponding current time stamp in data structure 300. Further, it determines 1240′, within the regression time window, a plurality of pressure gradients between the current pressure value and earlier pressure values stored in the data structure by determining the slopes s1, s2, s3 of further linear regression lines rl1, rl2, rl3 for the buffered pressure values within a plurality of regression windows w1, w2, w3. Each regression window ends with the buffered current pressure value pc and covering a different number of buffered pressure values. If the pressure gradients for the further regression windows indicate exceeding a predefined noise threshold, module 431 detects 1260′ the activation of the compressor.

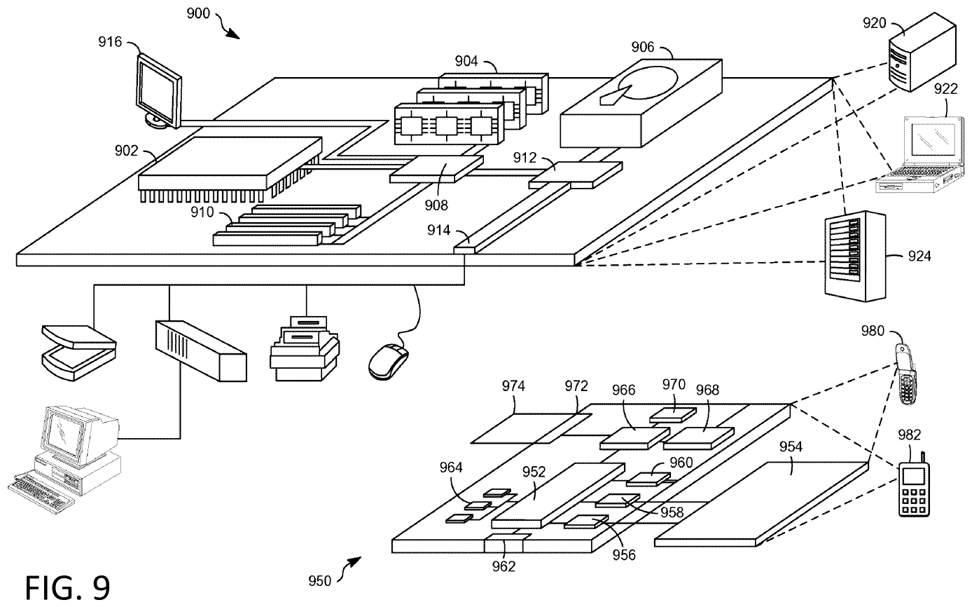

FIG. 9 is a diagram that shows an example of a generic computer device 900 and a generic mobile computer device 950, which may be used with the techniques described here. In some embodiments, computing device 900 may relate to system 400 (cf. FIG. 4). Computing device 950 is intended to represent various forms of mobile devices, such as personal digital assistants, cellular telephones, smart phones, and other similar computing devices. In the context of this disclosure the computing device 950 may provide I/O means for a user to interact with the computing device 900. For example, device 950 may be used to provide results obtained by device 900, such as the volumetric flow, to a user. The components shown here, their connections and relationships, and their functions, are meant to be exemplary only, and are not meant to limit implementations described and/or claimed in this document.

Computing device 900 includes a processor 902, memory 904, a storage device 906, a high-speed interface 908 connecting to memory 904 and high-speed expansion ports 910, and a low-speed interface 912 connecting to low-speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high-speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high-speed controller 908 manages bandwidth-intensive operations for the computing device 900, while the low-speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. hus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 984, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

1. A computer-implemented method for indirect measurement of a volumetric flow generated by a compressor in an environment with a known intake pressure, the compressor connected to a measuring volume extending up to a closed check valve downstream of the compressor, the check valve adapted for separating the compressor from a piping system supplying consumers, wherein a pressure sensor is located between the compressor and the check valve, the piping system adapted for transport of liquid and/or gaseous fluids, the method comprising:
sending activation instructions to the pressure sensor for capturing a time series of pressure values and corresponding time stamps at a sampling rate which is set to capture 3 to 100 pressure values during the time needed by the compressor to pump up the measuring volume to an operational working pressure where the check valve opens;
upon activation of the compressor, storing the captured pressure values with their time stamps in a memory;
computing a slope of a linear regression line for the pressure values captured during a regression time window between an activation timepoint of the compressor and a time point when the compressor reaches the operational working pressure; and
computing the volumetric flow generated by the compressor by multiplying the slope with a proportionality factor defined as a ratio of the measuring volume to the intake pressure.

2. The method of claim 1, wherein a filtering step excludes at least the pressure value succeeding the activation timepoint of the compressor, and excludes at least the pressure value preceding the timepoint when the compressor reaches the operational working pressure, such that remaining pressure values of the captured time series contain at least a minimum number of pressure values for computing the linear regression line.

3. The method of claim 1, further comprising:
upon activation of the pressure sensor, buffering each current pressure value with its corresponding current time stamp in a data structure;
determining, within the regression time window, a plurality of pressure gradients between the current pressure value and earlier pressure values buffered in the data structure by determining slopes of further linear regression lines for the buffered pressure values within a plurality of further regression windows, each further regression window ending with the buffered current pressure value and covering a different number of buffered pressure values;
if the pressure gradients for the further regression windows indicate exceeding a predefined noise threshold, detecting the activation of the compressor.

4. The method of claim 3, wherein the predefined noise threshold is determined from previously determined pressure values with the compressor being deactivated, wherein a sensor resolution is multiplied with a predefined tolerance factor which is adjusted in such a way that no set of calculated slopes during a known inactivity phase of the compressor exceeds the noise threshold.

5. The method of claim 1, further comprising:
upon activation of the compressor, buffering each current pressure value with its corresponding current time stamp in a buffer data structure;
determining a plurality of pressure gradients between the current pressure value and earlier pressure values stored in the data structure by determining the slopes of linear regression lines for the buffered pressure values within a plurality of further regression windows, each further regression window ending with the buffered current pressure value and covering a different number of buffered pressure values;
if the pressure gradients for the further regression windows indicate falling below an operating threshold obtained as previously determined slope of a linear regression line for pressure values previously captured during the time window between a previous activation timepoint of the compressor and a corresponding previous time point when the compressor has reached the operational working pressure, detecting the current time point as the time point when the compressor reaches the operational working pressure.

6. The method of claim 1, wherein the sampling rate which is set to capture 4 to 15 pressure values, preferably 12 pressure values, during the time needed by the compressor to pump up the measuring volume to an operational working pressure where the check valve opens.

7. A computer-implemented method for indirect measurement of a volumetric flow generated by a compressor in an environment with a known intake pressure, the compressor connected to a measuring volume comprising a test reservoir, the measuring volume extending up to a closed switching valve downstream of the compressor, the switching valve located between the compressor and a check valve, the check valve adapted for separating the compressor from a piping system and the switching valve adapted for separating the check valve from the measuring volume, wherein a pressure sensor is connected to or located in the test reservoir, the piping system adapted for transport of liquid and/or gaseous fluids, the method comprising:
sending activation instructions to the pressure sensor for capturing a time series of pressure values and corresponding time stamps at a sampling rate which is set to capture three to one hundred pressure values during the time needed by the compressor to pump up the measuring volume to a maximum working pressure;
upon activation of the compressor, storing the captured pressure values with their time stamps in a memory;
computing a slope of a linear regression line for the pressure values captured during a regression time window between an activation timepoint of the compressor and a time point when the compressor reaches the maximum working pressure; and
computing the volumetric flow generated by the compressor by multiplying the slope with a proportionality factor defined as a ratio of the measuring volume to the intake pressure.

8. The method of claim 7, wherein a filtering step excludes at least the pressure value succeeding the activation timepoint of the compressor, and excludes at least the pressure value preceding the timepoint when the compressor reaches an operational working pressure, such that remaining pressure values of the captured time series contain at least a minimum number of pressure values for computing the linear regression line.

9. The method of claim 7, further comprising:
upon activation of the pressure sensor, buffering each current pressure value with its corresponding current time stamp in a data structure;
determining, within the regression time window, a plurality of pressure gradients between the current pressure value and earlier pressure values stored in the data structure by determining the slopes of further linear regression lines for the buffered pressure values within a plurality of further regression windows, each further regression window ending with the buffered current pressure value and covering a different number of buffered pressure values;
if the pressure gradients for the further regression windows indicate exceeding a predefined noise threshold, detecting the activation of the compressor.

10. The method of claim 9, wherein the predefined noise threshold is determined from previously determined pressure values with the compressor being deactivated, wherein a sensor resolution is multiplied with a predefined tolerance factor which is adjusted in such a way that no set of calculated slopes during a known inactivity phase of the compressor exceeds the noise threshold.

11. The method of claim 7, wherein the sampling rate which is set to capture 5 to 14 pressure values, preferably twelve pressure values, during the time needed by the compressor to pump up the measuring volume to the maximum working pressure.

12. A computer program product for indirect measurement of the volumetric flow of a compressor in a first or second operating mode, comprising computer-readable instructions that, when loaded into a memory of a computing device and executed by one or more processors of the computing device, cause the computing device to execute the steps of the computer-implemented method according to claim 1 in the first operating mode, or according to claim 7 in the second operating mode.

13. A computer system for indirect measurement of the volumetric flow of a compressor in a first or second operating mode, comprising computer-readable instructions that, when loaded into a memory of a computing device and executed by one or more processors of the computing device, cause the computing device to execute the steps of the computer-implemented method according to claim 1 in the first operating mode, or according to claim 7 in the second operating mode.

14. A compressor system comprising:
a compressor unit adapted for compression of liquid and/or gaseous fluids;
a measuring volume extending up to a check valve downstream of the compressor unit, the check valve connected with the compressor unit by one or more connecting parts adapted for transport of liquid and/or gaseous fluids, and the check valve adapted to open when an operational working pressure is reached;
characterized in that a switching valve, placed between the check valve and the compressor unit, is adapted to disconnect the check valve from the compressor unit and the measuring volume while the compressor unit pumps up the measuring volume; and
a test reservoir associated with a pressure sensor, wherein the test reservoir is connected to the switching valve such that the test reservoir becomes part of the measuring volume pumped up by the compressor unit.

15. The compressor system of claim 14, wherein:
the switching valve is further adapted, when a maximum working pressure of the compressor unit is reached in the test reservoir, to close the connection between the test reservoir and the compressor unit, and to open the connection between the compressor unit and the check valve.
